(19) United States
(12) Patent Application Publication
(10) Pub. No.: US 2020/0040642 A1
(43) Pub. Date: Feb. 6, 2020

(54) METHOD FOR PRODUCING BLOCK MOUNTINGS AND APPLICATION DEVICE

(71) Applicant: NOLAX AG, Sempach Station (CH)

(72) Inventors: Beat BRUDERER, Zürich (CH); Patrick STEINER, Schattdorf (CH); Anton BRANDMAIR, Traunstein (DE)

(21) Appl. No.: 16/339,488

(22) PCT Filed: Aug. 22, 2017
(86) PCT No.: PCT/EP2017/071159

§ 371 Date: Apr. 4, 2019

(30) Foreign Application Priority Data
Oct. 11, 2016 (EP) 16193224.9

(51) Int. Cl. E06B 3/54; E06B 3/56; C09J 175/00; C08G 18/10

(52) U.S. Cl. CPC E06B 3/5409; E06B 3/5427; C08G 18/10; C09J 175/00; E06B 3/56

(57) ABSTRACT

A method for producing block mountings and an associated application device. The method for producing block mountings of windows (1) comprises the following steps: providing a frame made up of frame profiles (2) with one or more panes (3) arranged therein, wherein a gap (4) can be formed between at least one frame profile (2) and the one or more panes (3), fitting one or more, in particular adaptable, coverings (7) for covering an application region. The application region is delimited by the one or more coverings (7) in the peripheral direction, the frame profile (2) and the one or more panes (3). The one or more coverings has or have at least one opening, and the curable polymer (6) is introduced through the opening of the one or more coverings into the application region.

The invention relates to a method for producing block elements of windows, wherein fast-curing plastics materials form in particular the block element, and to an application device.

In the glazing of insulating windows, window casements, or glass doors, one or a plurality of panes are inserted into a prefabricated frame and fixed therein. The panes are in most instances combined in a relatively thick and heavy pane packet. The frame is composed of frame profiles. In the glazing of new frames, or else in repair jobs, blocks of plastics material are usually inserted between the periphery of the pane or of the pane packet and the frame rebate of the frame (block mounting). The blocks fix the panes or the pane packet in a central position. In the intended use of such a window the inserted blocks discharge the weight of the panes or of the pane packet onto the pivot bearing of the window.

Faulty block mountings typically lead to pane breakages since force and thus stresses within the panes are dissipated only insufficiently or in an uncontrolled manner. A faulty block mounting is generally understood as the wrong or insufficient positioning of the blocks. Damages created by faulty block mountings have to be repaired with complexity.

Methods for the block mounting of windows are known. DE 195 46 847 A1 describes a method for fixing panes in the rebate of a frame by spaced-apart inserting on the edge and subsequent block mounting using rebate inserts. Volumes enclosed on all sides within the inserted rebate inserts are filled with a liquid medium, and the rebate insert by way of impingement by pressure is thus moved in the direction of the edge of the pane until the rebate insert comes to bear.

EP 2 685 043 A1 describes a window or door casement from a frame having frame profiles and a pane package inserted therein. One or a plurality of glazing blocks are inserted in a frame gap between the periphery of the pane package and the rebate of a frame profile. At least one of the glazing blocks is configured so as to have an open base and cover face, and in the interior has a plastics-material filling which adhesively bonds the periphery of the pane package to the frame rebate. In the aforementioned methods and windows it is disadvantageous that the blocks are difficult to introduce. Further, any subsequent filling necessitates an additional method step.

EP 1 373 672 likewise describes the block mounting of windows. An adhesive layer is situated in a gap between the rebate and the insulating glazing, wherein a delimitation web for the adhesive layer which runs in the circumferential direction so as to be spaced apart from the rebate face is provided. The adhesive layer is formed from an elastic adhesive. The adhesive introduced tends to flow, and a block mounting for dissipating a large weight/large forces is thus not guaranteed.

It is an object of the invention to overcome the disadvantages of the prior art. It is in particular an object of the invention to provide a method in which no lateral delimitations have to be introduced into the frame gap. It is in particular a further object of the invention to provide an application device which enables a block mounting to be introduced in a simple manner.

The invention relates to a method for producing block elements of windows. The invention comprises the step of providing a frame from frame profiles having one or a plurality of panes arranged therein, in particular a pane packet arranged therein. A gap is configurable herein between at least one frame profile and the one or the plurality of panes. The method furthermore comprises the attaching of one or a plurality of, in particular adaptable, in particular temporary, covers for covering an application region. The application region herein is delimited by the one or the plurality of covers in the circumferential direction, the frame profile, and the one or the plurality of panes.

The one or the plurality of covers has/have at least one opening, in particular a bore. An opening can also understood to be a supply line through which the curable plastics material is introduceable into the application region. The method furthermore comprises the step of introducing the curable plastics material into the application region through the opening of the one or the plurality of covers. In this way, no to limitations in the longitudinal direction of the frame profile have to be introduced into the gap, so as to prevent any running-off of the introduced plastics material. The latter is advantageously initially liquid such that the introduction is possible, and cures rapidly. The method in this manner is more rapid and more reliable than methods for block mounting from the prior art. It is assumed that the plastics material introduced delimits itself laterally, this by gelling or by the increase in viscosity in the reaction (cross-linking or curing, respectively) of the plastics material, or by rheological properties such as, for example, structural viscosity or thixotropy.

Covers in the circumferential direction here and hereunder are understood to be covers which follow the gap substantially in the circumferential direction and cover the gap in regions. In this manner, sealing is performed at the height level of the surface of the glass, the application region is delimited toward the top, and the glass face is protected from contact with the adhesive.

The one or the plurality of covers can be wider than the application region, and can thus in regions also be positioned on the one or the plurality of panes, in particular the pane packet, and/or the frame profiles. This leads to particularly positive sealing of the application region. The one or the plurality of covers herein can also project beyond the application range in the circumferential direction.

The introduction of the curable plastics material is preferably casting or spraying. The introduction of the plastics material is particularly readily controllable in this way.

The one or the plurality of covers are preferably made from materials that are difficult to adhesively bond, such as, for example, polyethylene, polytetrafluoroethylene, polypropylene, or silicone. The covers can also be made from coated aluminum or steel.

In the method, one or a plurality of, in particular adaptable, in particular temporary, delimiters can delimit the application region in the longitudinal direction in relation to the frame profile. The delimiters in the sense of an air curtain can be applied as compressed air. To this end, a compressed air supply for a targeted introduction of compressed air can be provided. A plurality of compressed air supplies can likewise be provided. Alternatively, a second plastics-material system—in this case, the aforementioned curable plastics material forms the first plastics-material system—having a higher viscosity than the first plastics material system which forms the block element can be introduced as a lateral delimiter/lateral delimiters.

Delimiters in the longitudinal direction are understood to be delimiters which in relation to the frame profile are arranged or arrangable so as to be substantially transverse, in particular orthogonal, to the circumferential direction along the thickness of the one or the plurality of panes, in particular of the pane packet. In the case of two delimiters in the longitudinal direction being introduced, said two delimiters can of course differ from one another in terms of the angle to the circumferential direction of the frame profile. The delimiters in the longitudinal direction can be disposed or disposable so as to be transverse, in particular orthogonal, to the face of the profile on which the one or the plurality of panes, in particular the pane packet, bears/bear (cf. FIG. 2). In the case of two delimiters in the longitudinal direction being introduced, said two delimiters can of course differ from one another in terms of the angle to the face of the profile on which the one or the plurality of panes, in particular the pane packet, bears/bear. Furthermore, besides one or a plurality of covers in the circumferential direction, one or a plurality of delimiters in the longitudinal direction can be disposed or disposable so as to be transverse, in particular orthogonal, to the circumferential direction along the thickness of the one or the plurality of panes, in particular the pane packet.

The method can furthermore comprise the curing of the introduced plastics material. In this manner, the introduced plastics material is rendered as a stress-capable block which has the known requirements to be met by the window block element, such as, for example, the compensation of dimension and production tolerances of the window and the uniform dissipation of stresses of the glasses. The plastics material is in particular covered by the, in particular adaptable, in particular temporary, covers for a period until the plastics material has sufficiently cured.

The application region, or the dimensions of the application region, respectively, depend on the gap size, preferably in the range from 1 to 5 mm; the thickness of the one or the plurality of panes, in particular the pane packet, preferably in the range from 18 to 60 or 100 mm. The length of the block element can be in the range from 25 to 300 mm, preferably 50 to 150 mm, particularly preferably 75 to 125 mm. At an optimum, the block element can have a length of 100 mm. The application region can have dimensions in the range from 2 mm×18 mm×50 mm to 9 mm×100 mm×300 mm, preferably 3 mm×36 mm×100 mm, particularly preferably 4 mm×40 mm×100 mm. Since the in particular adaptable, in particular temporary, covers are adaptable to the dimensions of the gap, an application range having the aforementioned dimensions can be conceived. In this way, a gap having the aforementioned dimensions can in regions be filled with the curable plastics material.

The curable plastics material can be based on fast-curable polyurea adhesives. The latter are in general bi-component adhesives comprising an isocyanate-containing component A and an amine-containing component B, wherein the component A contains an isocyanate-terminated prepolymer and the component B at least one diamine and/or polyamine and/or polyether polyamine. Adhesive compositions of this type are described in EP 1 958 975 A1 and are herewith incorporated by reference. In this way, the plastics material cures fast, this enabling high cycle rates in the production process. The component A can moreover comprise a monomer polyisocyanate.

The aforementioned plastics material based on a fast-curing polyurea adhesive can furthermore comprise a trimerization catalyst, in particular in the component B. In particular, metallic salts of a carbonic acid, preferably potassium octoate and potassium acetate, phosphine, sodium hydroxide, potassium hydroxide, quaternary ammonium salts, 2,4,6-tris(dimethylaminomethyl)phenol, and/or other mixtures of catalysts such as, for example Jeffcat TRC) (Huntsman) can be used as trimerization catalysts. The following commercial products can also be used as catalysts: DABCO K-15, DABCO TMR, DABCO TMR-7, DABCO TMR-20, Polycat 46 (all by Air Products), as well as Niax C-41 (by Momentive).

The curable plastics material can comprise fillers, preferably selected from the list comprising pyrogen and precipitated silica, bentonite, chalk, china clay, wollastonite, mica, molecule sieves, glass spheres, carbon black, natural rubbers, silicones, titanium dioxide.

The curable plastics material can be a structural viscous adhesive. Structural viscous adhesives are advantageous since they do not flow or flow only when shear forces are exerted, do not sink in porous substrates, the fillers do not settle or float and have a minor separating behavior of incompatible components. When a structural viscous adhesive is used, the latter need not be a fast-curing system since the adhesive by virtue of the structural viscosity thereof does not flow in the non-cured state. Structural viscous, fast-curing systems can likewise be used.

The curable plastics material can be a thixotropic adhesive. Said thixotropic adhesive is advantageous since the latter in the non-cured state does not flow in the absence of mechanical stress. Fast-curing and slow-curing systems can be used herein.

A fast system here and hereunder is understood to be a curable plastics material which is designed in such a manner that said curable plastics material has a tensile strength of >0.1 MPa after 2 to 20 s, preferably 5 to 15 s, particularly preferably 7 to 12 s, after the introduction into the application region. The tensile strength is determined by the tensile shear test according to DIN 53283, September 1979.

The introduction time in the sense of shot time for the introduction of the curable plastics material is preferably in the range from 0.25 to 1.75 s, preferably 0.5 to 1.5 s, particular preferably 0.75 to 1.25 s.

The introduction rate in the sense of application lines for the introduction of the curable plastics material is preferably in the range from 10 to 40 g/s, preferably 15 to 35 g/s, particularly preferably 20 to 30 g/s. In this manner, the plastics material reaches up to the cover and is of substantially identical width at the top and the bottom.

The method according to the invention can be adapted to the relevant situation by the adjustment of the introduction time and the introduction rate.

The curable plastics material can be adjusted in such a manner that the curable plastics material when curing adhesively bonds to the frame profile and/or the one or the plurality of panes, in particular the pane packet, and/or a sealant which seals and holds together a plurality of panes, in particular in a pane packet. This means that the curable plastics material adhesively bonds either only to the frame profile or to the one or the plurality of panes and/or to the sealant, if present. Alternatively, the curable plastics material can adhesively bonded to the frame profile as well as to the one or the plurality of panes and/or to the sealant, if present. An adhesive bond can in this way be performed according to requirements.

An application device can furthermore be provided. An in particular fast-curing, curable plastics material can be introduced by means of the application device. The plastics material herein is introduced into the gap configured between the frame profile and the one or the plurality of panes. The introduction procedure can be controlled in an optimal manner by means of the application device; in particular, the application quantity, the introduction rate, and the application position can be performed in a reproducible manner. Faulty block elements are minimized in this way.

The application device can comprise the, in particular adaptable, in particular temporary, covers explained above. When moving the application device toward an application position, a gap between the frame profile and the one or the plurality of panes is configured and the, in particular adaptable, in particular temporary, covers are attached. As has been described above, the covers define the application region, or the dimensions of the application region, respectively. The process sequence is accelerated in this way, and high cycle rates can be achieved for the block mounting process. In as far as lateral delimiters are provided, the latter can likewise be comprised by the application device.

A clamping, expanding, or sliding device can also be used for configuring the gap. A device of this type advantageously ensures the configuration of the gap between the frame profile and the one or the plurality of panes. Said device of this type can likewise be integrated in the application device. The steps of configuring the gap, attaching covers, and introducing plastics material are thus performed in a rapid sequential manner, or almost simultaneously, respectively. The process sequence is accelerated in this way, and high cycle rates can be achieved for the block mounting process.

The method can be carried out manually or be automated. The method can likewise be partially automated or semi-automated, respectively. Process parameters such as, for example, positions of the block element, number of block elements per frame, dimensions of the blocks, introduction times of the plastic material, and cycle rates can be chosen and carried out in a manner specific to the application by means of the automated method. To this end, a control unit and respective robots can be provided. The method in this way is capable of being carried out at particularly high cycle rates and minor susceptibility to faults. In comparison to the manual introduction of block elements, faulty block elements are minimized by the automated method.

A further aspect of the invention relates to an application device for introducing a curable, in particular fast-curable, plastics material. The application device comprises an in particular adaptable, in particular temporary, cover having at least one opening, in particular a bore, or a plurality of in particular adaptable, in particular temporary, covers (7) having at least one opening, in particular a bore, for a method for block mounting. The method is preferably the method according to the invention explained above. The cover in the situation according to the application covers the application region.

The cover herein can be wider than the application region and thus in the use also be positioned in the regions onto the one or a plurality of panes, in particular the pane packet, and/or the frame profiles. This leads to particularly positive sealing of the application region. The cover herein can also protrude beyond the application range in the circumferential direction.

The application device (as an add-on unit) can be fastened directly to the exit location of the plastics material on a mixing element, or be conceived as an integral component part of the mixing element. The application device can be composed of a supporting and sealing beam in the sense of a support. The support, when the latter is disposed on the gap, forms a cover in the circumferential direction. Further delimitation elements for delimiting the application region in the longitudinal direction can be disposed at an angle of approx. 90° to the support at the ends of the support.

In as far as provided, said delimitation elements are introduced into the existing gap between the glass and the rebate of the frame profile. Said delimitation elements prevent the introduced plastics material from running off in the longitudinal direction. The delimiters in the longitudinal direction thus laterally seal the cavity thus created, which corresponds to the application region. The delimiters in terms of height can be variable and thus adaptable.

The cover can delimit and seal the cavity in the circumferential direction in relation to the surface of the one or the plurality of panes, in particular the surface of a pane packet. After the application, or the injection, of the curable plastics material, in particular a plastics material as has been described above, and the curing of said plastics material, the application device conjointly with the covers can be released and removed manually, semi-automatically, or automatically. Alternatively, the aforementioned delimiters can be conceived as lost formwork which remains within the application region.

The lateral delimiters can be based on compressed air, as has been explained above, and have the design embodiments and advantages described above.

The application device can comprise at least one material supply for providing curable plastics material or components for a curable plastics material. Of course, a plurality of, in particular two, material supplies can also be provided. In this manner, curable plastics material can be provided so as to be adapted to the application and the situation.

The application device can have introduction times in the sense of shot times for the introduction of the curable plastics material in the range from 0.25 to 1.75 s, preferably 0.5 to 1.5 s, particularly preferably 0.75 to 1.25 s.

The application device can have introduction rates in the sense of application lines for the introduction of the curable plastics material in the range from 10 to 40 g/s, preferably 15 to 35 g/s, particular preferably to 30 g/s. In this manner, the plastics material reaches up to the cover and is of substantially identical width at the top and the bottom.

### EXEMPLARY EMBODIMENT

An exemplary plastics material composition which can be used in the method according to the invention can be derived from the following table.

| Components | Product name |
|---|---|
| Isocyanate component (A) | W45.5003 (by Nolax) |
| Amine mixture component (B) | W45.3062 (by Nolax) |
| Mixture A:B | 100:80 by weight or |
| | 100:95 by volume |
| Viscosity of A | 200 mPa*s at 20° C. |
| | (Brookfield Sp. 5/20 rpm) |
| Viscosity of B | 1000 mPa*s at 20° C. |
| | (Brookfield Sp. 5/20 rpm) |

The application region according to the exemplary embodiment has dimensions of 100 mm×36 mm×4 mm. The plastics material mentioned was introduced into the application region at an introduction rate of 23 g/s and an introduction time of 0.75 s. The curing time, measured from the introduction of the plastics material, was 4 to 5 s. The curing time corresponds to that time after which the plastics material has a tensile strength of >0.1 MPa (determined as has been explained above).

The invention will be explained in more detail hereunder by means of illustrations of exemplary embodiments. In the figures:

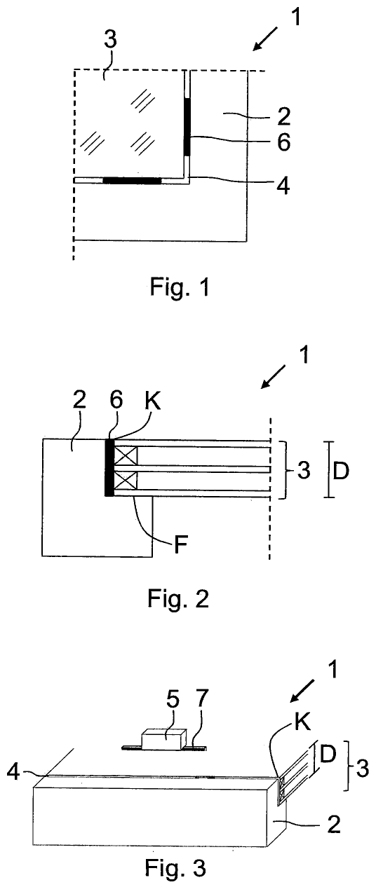

FIG. 1 shows a side view of a window region having block elements;

FIG. 2 shows a section of a window region having a block element;

FIG. 3 shows a perspective view of a frame profile having a first application device according to the invention;

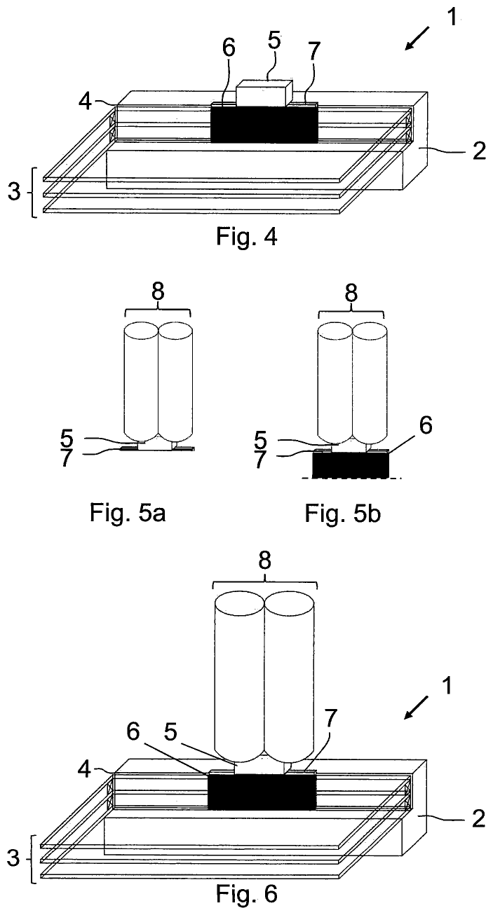

FIG. 4 shows a perspective view of a frame profile having a first application device according to the invention at the gap;

FIG. 5a shows a perspective view of a second embodiment of the application device according to the invention;

FIG. 5b shows a perspective view of a second application device according to the invention, having a filled application region; and

FIG. 6 shows a perspective view of a profile frame having a second application device according to the invention, having a filled application region.

FIG. 1 shows a side view of a region of a window 1 having block elements. The window 1 comprises a frame profile 2, a pane packet 3, a gap 4 which is situated between the frame profile 2 and the pane packet 3, and plastics materials 6 that have cured so as to form blocks. The blocks of the cured plastics material 6 in the installed operating state of the window 1 dissipate the weight of the pane packet 3 to the frame profile 2. Stresses arising in individual panes of the pane packet 3 are minimized and a glass breakage is prevented by a targeted dissipation of the forces.

FIG. 2 shows a section of a region of a window having a block element. The pane packet 3 bears on the face F on the frame profile 2. A block of cured plastics material 6 is introduced between the frame profile 2 and the pane packet 3. A spacer which conjointly with the edges K of the panes in the contact region toward the block of cured plastics material 6 forms a contact face is situated between individual panes of the pane packet 3. A thickness D of the pane packet 3 is shown. Said contact face delimits the application region in such a manner that the curable plastics material 6 when introduced does not make its way between individual panes of the pane packet 3. The frame profile 2 and the contact face of the pane packet 3 thus form a lower and an upper delimiter for the curable plastics material 6.

FIG. 3 shows a perspective view of a frame profile 2, a pane packet 3, and a first application device 5 according to the invention. A thickness D of the pane packet 3 is shown. Spacers which conjointly with the edges K of the panes form a contact face are situated between individual panes of the pane packet 3. The application device 5 comprises an in particular adaptable cover 7 which in the state attached to the gap 4 covers an application region between the frame profile 2 and the pane packet 3 in the gap 4. The in particular adaptable cover 7 covers the application region in the circumferential direction of the frame profile 2. The frame profile 2, the contact face of the pane packet 3, as well as the cover 7 thus define the application region for a curable plastics material (cf. FIG. 4). In the case of a corresponding choice of the curable plastics material, no delimiters for delimiting the application region in the longitudinal direction of the frame profile 2 in the gap 4 are required, which delimiters would intended to prevent the introduced plastics material from flowing.

FIG. 4 shows a perspective view of a frame profile 2, a pane packet 3, and a first application device 5 according to the invention, having a cover 7, wherein the cover 7 is attached to the gap 4. A curable plastics material 6, by means of the application device 5, is introduced in an application region which is defined as has been explained above in the context of FIG. 3. The cycle rates of the method according to the invention are thus increased, and the method is simplified. This leads to fewer faulty block mountings.

FIGS. 5a and 5b show a second application device 5 according to the invention, which has an in particular adaptable cover 7 for attaching to a gap 4 (cf. FIGS. 1 to 4). The cover 7 enables an application range to be delimited to a frame profile in the circumferential direction. The application device 5 comprises a material supply 8 which comprises two or a plurality of chambers. Two cylindrical chambers in which components for a curable plastics material can be situated are illustrated. When the cover 7 for introducing a curable plastics material is attached to a gap (cf. FIGS. 1 to 4), the components can be mixed and then introduced into the application range. FIG. 5b, by contrast to FIG. 5a, shows a plastics material 6 introduced into the application region. And has been explained above, the application region is further delimited by a frame profile and a pane packet (not shown here).

FIG. 6 shows a perspective view of a frame profile 2, a pane packet 3, and a second application device 5 according to the invention (cf. FIGS. 5a and 5b). The application device 5 has a cover 7 wherein the cover 7 is attached to the gap 4. The application device 5 furthermore comprises a material supply 8 which for providing individual components of the plastics material comprises two or a plurality of chambers. Two cylindrical chambers are shown. Of course, only one or more than two chambers can also be provided. The components of the plastics material are mixed, and a curable plastics material 6, by means of the application device 5, is introduced in a corresponding manner into an application region which is defined as has been explained above in the context of FIG. 3. The application region in the circumferential direction of the profile frame is delimited by the cover 7, as well as by the contact face of the pane packet 3 and the frame profile.

1. A method for producing block elements of windows, said method comprising the following steps:
providing a frame from frame profiles having one or a plurality of panes arranged therein wherein a gap between at least one frame profile and the one or the plurality of panes can be formed;
attaching one or a plurality of covers for covering an application region, wherein the application region is delimited by the one or the plurality of covers in the circumferential direction, the frame profile, and the one or the plurality of panes, wherein the one or the plurality of covers has/have at least one opening;
introducing a curable plastics material into the application region through the opening of the one or the plurality of covers.

2. The method as claimed in claim 1, wherein one or a plurality of delimiters delimit the application region in the longitudinal direction in relation to the frame profile.

3. The method as claimed in claim 1, comprising the step of curing the introduced plastics material.

4. The method as claimed in claim 1, wherein the application region has dimensions in the range from 2 mm×18 mm×50 mm to 9 mm×100 mm×300 mm.

5. The method as claimed in claim 1, wherein the curable plastics material is based on fast-curable polyurea adhesives.

6. The method as claimed in claim 5, wherein the curable plastics material comprises a trimerization catalyst.

7. The method as claimed in claim 1, wherein the introduction time for introducing the curable plastics material is in a range from 0.25 to 1.75 s.

8. The method as claimed in claim 1, wherein an introduction rate for introducing the curable plastics material is in a range from 10 to 40 g/s.

9. The method as claimed in claim 1, wherein the curable plastics material is adjusted in such a manner that the curable plastics material, when curing, adhesively bonds to at least one of the frame profile and the one or the plurality of panes.

10. The method as claimed in claim 1, wherein an application device for introducing a curable plastics material is provided.

11. The method as claimed in claim 10, wherein the application device comprises the one or the plurality of covers.

12. The method as claimed in claim 1, wherein the method is automated.

13. An application device for introducing a curable plastics material, said application device comprising a cover having at least one opening or a plurality of covers having at least one opening.

14. The application device as claimed in claim 13, comprising one or a plurality of delimiters.

15. The application device as claimed in claim 13, comprising at least one material supply for providing curable plastics material or components for a curable plastics material.

16. The method according to claim 1, wherein the frame from frame profiles has a pane packet arranged therein.

17. The method according to claim 1, where the one cover or the plurality of covers is/are at least one of adaptable and temporary.

18. The method according to claim 2, wherein the one delimiter or the plurality of delimiters is/are at least one of adaptable and temporary.

19. The application device according to claim 13, wherein the cover or the plurality of covers is/are at least one of adaptable and temporary.

20. An application device for introducing a curable plastics material, said application device comprising a cover having at least one opening or a plurality of covers, wherein the application device is for the method as claimed in claim 10.

21. The application device according to claim 14, wherein the delimiter or the plurality of delimiters is/are at least one of adaptable and temporary.
